(19) United States
(12) Patent Application Publication
(10) Pub. No.: US 2010/0162376 A1
(43) Pub. Date: Jun. 24, 2010

(54) AUTHENTICATION SYSTEM AND METHOD USING DEVICE IDENTIFICATION INFORMATION IN UBIQUITOUS ENVIRONMENT

(75) Inventors: Youn Seo Jeong, Daejeon (KR); Jae Gi Lee, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/491,431

(22) Filed: Jun. 25, 2009

(30) Foreign Application Priority Data
Dec. 18, 2008 (KR) 10-2008-0129100

(51) Int. Cl. G06F 21/20; H04L 9/32

(52) U.S. Cl. 726/9; 726/3; 726/5

(57) ABSTRACT

An authentication system using device identification information in ubiquitous environment includes: an information reader for receiving authentication information of a user through at least one device of the user; a home gateway and an office gateway for registering the user authentication information received from the information reader, and performing service control through verification of authentication of the user; and an integrated authentication center for receiving the user authentication information from the home gateway and the office gateway by querying, in response to a request for the authentication of the user received from a specific system, and, when the respective pieces of the user authentication information are identical to each other, transmitting an authentication success message to the specific system.

### CROSS-REFERENCE(S) TO RELATED APPLICATION(S)

The present invention claims priority of Korean Patent Application No. 10-2008-0129100, filed on Dec. 18, 2008, which is incorporated herein by reference.

### FIELD OF THE INVENTION

The present invention relates to authentication technology in ubiquitous environment; and, more particularly, to an authentication system and method using device identification information in ubiquitous environment, which are suitable for strengthening the authentication of users at the time of providing a ubiquitous service.

### BACKGROUND OF THE INVENTION

Generally, a computing system controls access to a system or use of a service, using identifiers capable of identifying users, such as Identifications (IDs), passwords, certificates, security tokens (e.g., One-Time Passwords: OTPs), admission cards, and biometric information.

Recently, when using e-commerce or changing personal information, a user is requested to transmit the identification information of a mobile phone, so as to identify the user, and thus only the identified user is permitted to use e-commerce or to change his or her information.

However, when a specific user happens to get ID and password of some other user on the Internet, the specific user may post text slandering a third party while concealing his or her identity, or may illegally use the ID of the some other user and access the Internet. Further, hacking technologies to illegally acquire ID information, credit card registration information, etc. of some other users have also been developed, and this information, illegally acquired through the hacking technologies, has been actually used for various types of crimes.

Therefore, recently, services for providing more secure payment using a mobile phone as an auxiliary authentication means at the time of performing e-commerce using credit cards or the like have been provided. However, such a service is disadvantageous in that the accuracy thereof has an error ranging from several tens of meters to several hundreds of meters, and in that when both the mobile phone and the credit card of a specific user are acquired by another user, illegal use of personal information cannot be prevented.

Meanwhile, ID, a password or a public (or private) certificate replaces an identification card on Internet services. However, managing the ID, password or certificate thoroughly is actually difficult, and when the ID, password or certificate is externally leaked, security may be destroyed.

Further, even if a worker having no management authority to a specific restricted area accesses an important system or facility, enters the system or facility using an illegally acquired ID or admission card, and then conducts any unauthorized operation, it is difficult to prevent such operations.

In a conventional security system operated as described above, a complicated security system has been implemented through simultaneous authentication using a mobile phone, as well as ID and a password, and through authentication using a certificate or the like, instead of using only an ID and a password, with respect to fields requiring security such as card payment, Internet access and admission to a restricted area. However, this complicated security system is also disadvantageous in that, when a specific user's mobile phone or the user's certificate password is acquired by another user, there is no special solution to keep security.

### SUMMARY OF THE INVENTION

In view of the above, the present invention provides an authentication system and method using device identification information in ubiquitous environment, which can strengthen authentication at the time of requesting a service or authenticating users in ubiquitous environment.

Further, the present invention provides an authentication system and method using device identification information in ubiquitous environment, which can strengthen the authentication of users at the time of providing a ubiquitous service (U-service), by integrating authentication information collected from devices possessed or carried by the users and analyzing the collected authentication information.

In accordance with one aspect of the present invention, there is provided an authentication system using device identification information in ubiquitous environment, including:

an information reader for receiving authentication information of a user through at least one device of the user;

a home gateway and an office gateway for registering the user authentication information received from the information reader, and performing service control through verification of authentication of the user; and

an integrated authentication center for receiving the user authentication information from the home gateway and the office gateway by querying, in response to a request for the authentication of the user received from a specific system, and, when the respective pieces of the user authentication information are identical to each other, transmitting an authentication success message to the specific system.

In accordance with another aspect of the present invention, there is provided an authentication method using device identification information in ubiquitous environment, including:

when a request for verification of authentication of a user is received from a specific system, individually requesting a home gateway and an office gateway to transmit authentication information of the user, registered in the home gateway and the office gateway;

determining whether pieces of user authentication information respectively received from the home gateway and the office gateway are identical to each other; and

transmitting an authentication success message to the specific system if it is determined that the pieces of user authentication information are identical to each other.

### BRIEF DESCRIPTION OF THE DRAWINGS

The above features of the present invention will become apparent from the following description of embodiments given in conjunction with the accompanying drawings, in which:

FIG. 1 shows a block diagram of a ubiquitous home (hereinafter, U-home) gateway in accordance with an embodiment of the present invention;

FIG. 2 is a diagram showing a connection of a U-home to external systems in accordance with the present invention;

FIG. 3 is a diagram showing a connection of a U-office gateway to external systems in accordance with another embodiment of the present invention; and

FIG. 4 is a diagram showing a process for checking access by a user in ubiquitous environment in accordance with the present invention.

### DETAILED DESCRIPTION OF THE PREFERRED EMBODIMENTS

Hereinafter, embodiments of the present invention will be described in detail with reference to the accompanying drawings.

The present invention is intended to strengthen authentication of users, at the time of providing a ubiquitous service, by integrating authentication information collected from various devices possessed or carried by users and analyzing the authentication information.

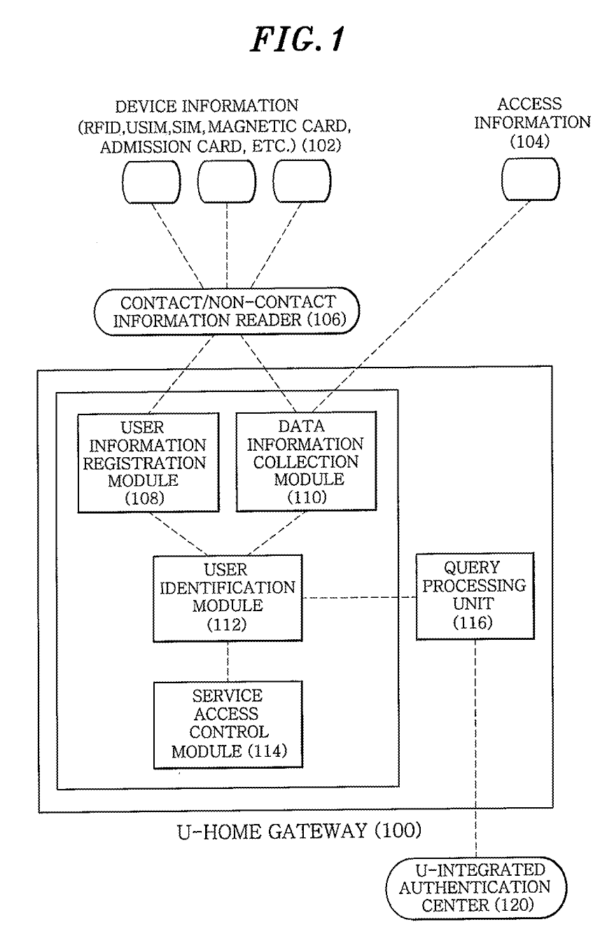

FIG. 1 shows a block diagram of a ubiquitous home (hereinafter, U-home) gateway in accordance with an embodiment of the present invention.

Referring to FIG. 1, a U-home gateway 100 is a device located at a connection point between a U-home and external systems and includes a user information registration module 108, a data information collection module 110, a user identification module 112, a service access control module 114, and a query processing unit 116. The U-home gateway 100 not only performs data transmission between a home network and an external network but also takes charge of various functions, in particular, a function of registering various device information of a user.

The U-home gateway 100 registers and manages information on devices capable of identifying the user. The device information that can be registered may be identification information about all contact or non-contact type of devices containing user identification information, as well as identification information about devices equipped with RFID (Radio Frequency Identification) tags, credit cards implemented as magnetic cards, and SIM (Subscriber Identity Module) cards or USIM (Universal Subscriber Identity Module) cards which are mounted in mobile phones. Such identification information may also include information such as the simple tag information of products as well as information required to identify users.

A contact/non-contact information reader 106 is installed in the u-home network, to identify information from the devices of a user. Then, the identified information is transmitted to the user information registration module 108. The user information registration module 108 registers the identification information of the respective user devices. The registered information is used to identify the user when the user comes back to his or her home. That is, the registered information is compared with respective pieces of information from devices carried by the user to identify him/her. When the user is identified, the U-home provides services suitable for the user or requested by the user.

The data information collection module 110 collects, if necessary, access information 104 (biometric information, a password assigned to a person, admission card information and the like) for the entrance of the U-home, with the identification information of devices carried by a person who desires to enter the entrance. The collected information is provided to the user identification module 112. Accordingly, the user identification module 112 identifies the user based on the collected identification information. Such identification information is previously set by the user or a manager for respective services to be provided. In this case, conditions for identifying the user in the user identification module 112 may be designated differently depending on the number of pieces of information required for authentication, an importance level of device information, and an accuracy of information.

The service access control module 114 determines whether to provide or block a service on the basis of the results received from the user identification module 112, and then provides or blocks the service according to the determination.

When a request for identification information registered by the user is received from an external U-integrated authentication center 120, the query processing unit 116 transfers the request to the user identification module 112, receives a response message from the user identification module 112, and transmits the response message to the U-integrated authentication center 120.

The U-integrated authentication center 120 receives user identification information from a U-office gateway as well as the U-home gateway 100, integrates the pieces of user identification information from each gateway, and determines whether to authenticate the user or not.

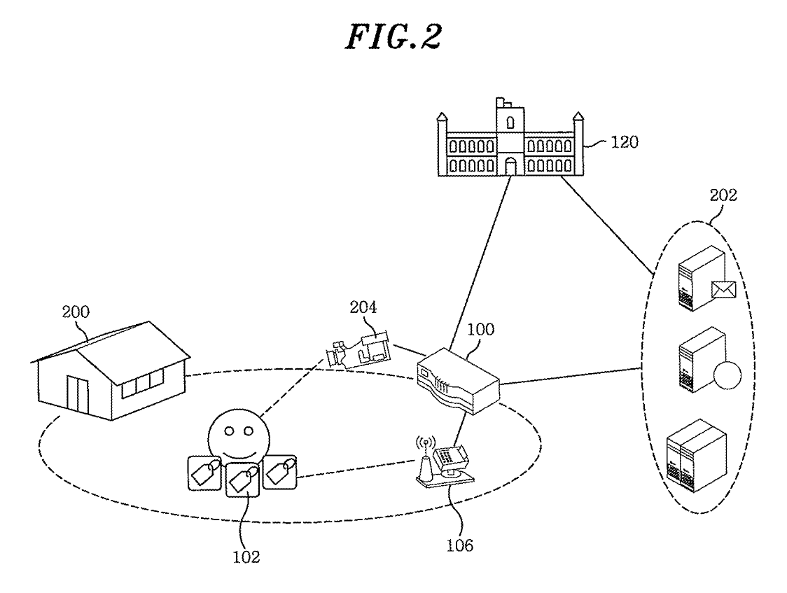

FIG. 2 is a diagram showing a connection of a U-home to external systems in accordance with the present invention.

Referring to FIG. 2, in a U-home 200, an identification of a user can be verified using information registered in the U-home gateway 100. When a card or an identification number has been individually assigned to users, the user may be identified through the card or the identification number. When there is a camera 204 inside or outside the U-home 200, the user may be identified through image recognition information, such as the user's action or the user's face, captured by the camera 204. When the user carries his/her own devices 102, the user may be identified by the contact/non-contact information reader 106. If the user is verified through such identification process, a relevant service is provided to the user.

Here, the U-home gateway 100 transmits or receives various types of user identification information in cooperation with the U-integrated authentication center 120 and a personal/business purpose system 202, thereby enabling more accurate and further strengthened authentication system to be implemented.

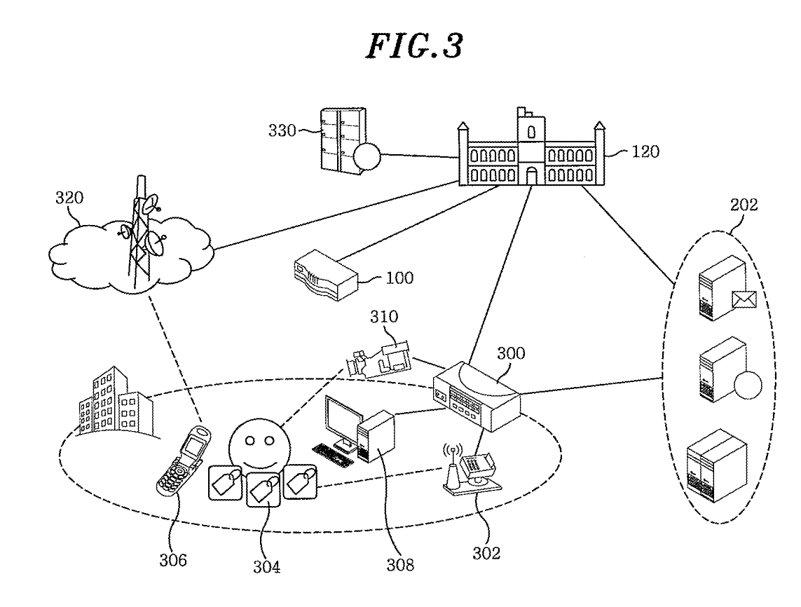

FIG. 3 is a diagram showing a connection of a U-office gateway to external systems in accordance with another embodiment of the present invention.

Referring to FIG. 3, a U-office gateway 300 takes charge of an area whose size is about a size of an office, managing a connection of the area to external systems. That is, the U-office gateway 300 responds to a request for the authentication information of a specific user from the U-integrated authentication center 120, in association with the U-integrated authentication center 120 and the personal/business purpose system 202, and provides the specific user with a service through the verification of authentication information in cooperation with the personal/business purpose system 202.

Further, the U-office gateway 300 may manage the entire building in cooperation with contact/non-contact information readers 302 and cameras 310 located in respective posts or respective floors.

Meanwhile, the U-gateway 300 can detect a location of a user through an external mobile terminal location information management system 320 connected to a mobile phone 306 of the user. The U-integrated authentication center 120 having received information about a computer 308 of a user within the office may detect a location of the user's computer 308 using the IP (Internet Protocol) address of the computer 308 in cooperation with an IP address location information management system 330.

The mobile terminal location information management system 320 and the IP address location information management system 330 transmit or receive information in association with the U-integrated authentication center 120. The U-office gateway 300 shares authentication information with the U-integrated authentication center 120 through a request for the transmission/reception of user authentication information, and thus authenticates the user based on the authentication information.

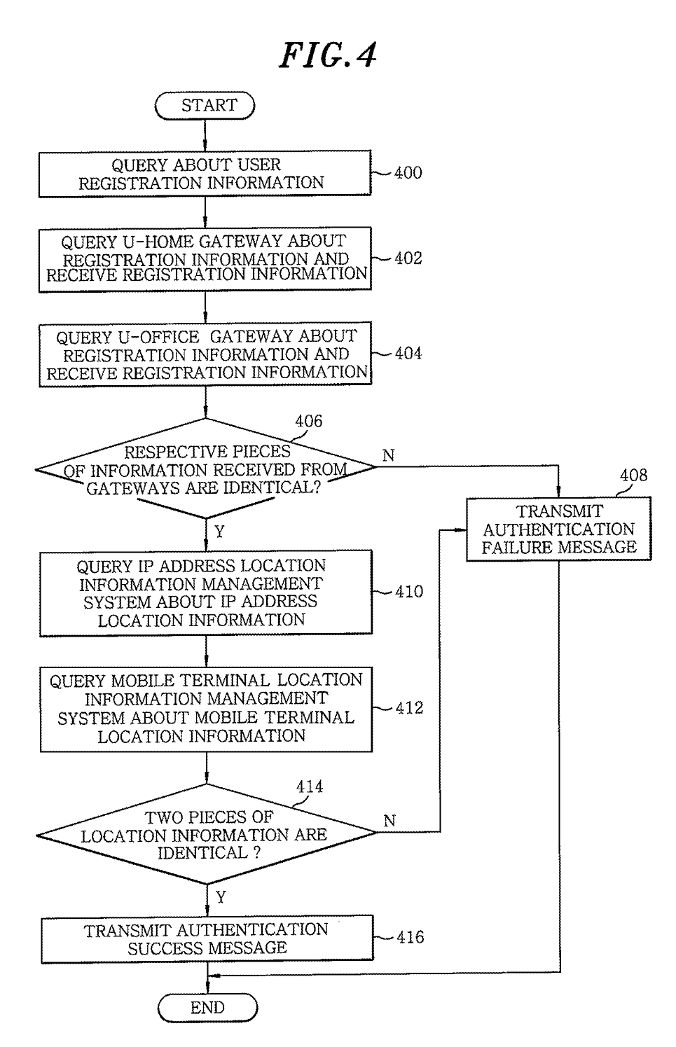

FIG. 4 is a flowchart showing a process for checking access of a user in ubiquitous environment in accordance with the present invention.

Referring to FIG. 4, when a user try to access to a system in order to use services thereof, the system first query the U-integrated authentication center 120 about user registration information using ID of the user at step 400. The U-integrated authentication center 120 receives the registration information of the corresponding user from the U-home gateway 100 by request at step 402. At step 404, the U-integrated authentication center 120 requests collected device identification information of the user from the U-office gateway 300, and then compares the received device identification information of the user with the user registration information received from the U-home gateway 100.

When the two pieces of information are found not to be identical to each other at step 406, a message indicating that authentication has failed is transmitted to the system which queried about the user registration information at step 408. However, when the two pieces of information are found to be identical to each other at step 406, the U-integrated authentication center 120 queries the IP address location information management system 330 about IP address location information at step 410. From a response to the query about the IP address location information, the U-integrated authentication center 120 makes sure whether the computer of the user is located in the area where the U-office gateway 300 accessed by the user is installed. At step 412, the U-integrated authentication center 120 requests user information from the mobile terminal location information management system 320. When the location information of the mobile terminal of the user is received, the U-integrated authentication center 120 determines whether the pieces of registration information received from the above gateways are identical to the location information of the IP address and the location information of the mobile terminal at step 414.

Since there is a possibility that the user has lost or is not carrying the mobile terminal, the location information of the mobile phone is not essential information. In this case, information on the loss of the mobile terminal is automatically transferred to the U-integrated authentication center 120 by the user's report, so that the location information of the mobile terminal is excluded from information required for the verification of user authentication.

Next, if it is determined at step 414 that at least one of the above pieces of information is not identical to the user registration information, a message indicating that authentication has failed is transmitted, at step 408, to the system which queried about the user registration information.

However, if it is determined at step 414 that all pieces of information are identical to the user registration information, an authentication success message is transmitted, at step 416, to the system which queried about the user registration information.

The system which queried about the user registration information provides the user with a service requested by the user after verifying user authentication information through the above procedure.

The present invention can register and manage the identification information of various devices which are used and carried by users, so that it provides more convenient and further strengthened authentication using the identification information, unlike a method of processing authentication for the use of a system, a network or a service using only a single piece of authentication information. Further, the present invention can perform authentication based on other pieces of registered information without requiring a specific authentication means, and can freely combine and use respective pieces of authentication information by selecting suitable authentication information and determining the number of pieces of authentication information according to the characteristics of a service.

Through the above process, the present invention has advantages in that actions of illegally accessing a remote system using ID of a third party or posting slanderous text may be prevented. In addition, when a credit card or an admission card has been stolen, the illegal use of the cards is prevented using an authentication system having strengthened location information. Further, since locations of users can be identified within the range of management areas of the U-office gateway and the U-home gateway, more accurate locations of the users can be detected when compared to existing mobile terminal-based location tracking method.

While the invention has been shown and described with respect to the embodiments, it will be understood by those skilled in the art that various changes and modifications may be made without departing from the scope of the invention as defined in the following claims.

What is claimed is:

1. An authentication system using device identification information in ubiquitous environment, comprising:
an information reader for receiving authentication information of a user through at least one device of the user;
a home gateway and an office gateway for registering the user authentication information received from the information reader, and performing service control through verification of authentication of the user; and
an integrated authentication center for receiving the user authentication information from the home gateway and the office gateway by querying, in response to a request for the authentication of the user received from a specific system, and, when the respective pieces of the user authentication information are identical to each other, transmitting an authentication success message to the specific system.

2. The authentication system of claim 1, wherein the home gateway includes:
a registration module for registering the user authentication information received from the information reader;
a data information collection module for collecting access information of the user in association with the registration module;
a user identification module for identifying the user based on the user authentication information and the user access information;
a service access control module for determining whether to provide a service to the user based on a result of the identification performed by the user identification module; and
a query processing unit for requesting authentication information of a specific user from the user identification module, in response to a request for information of the specific user received from the integrated authentication center, and, when the authentication information of the specific user is received from the user identification module, transmitting the authentication information of the specific user to the integrated authentication center.

3. The authentication system of claim 1, further comprising:
an IP (Internet Protocol) address location information management system for receiving information about an IP address of a computer accessed by the user from the integrated authentication center and providing location information of the IP address.

4. The authentication system of claim 3, further comprising:
a mobile terminal location information management system for providing information about a location of a mobile terminal used by the user, based on signals transmitted or received by the mobile terminal.

5. The authentication system of claim 4, wherein the integrated authentication center receives the respective pieces of location information from the IP address location information management system and the mobile terminal location information management system, and transmits the authentication success message to the specific system when the respective pieces of location information of the user are identical to the user authentication information.

6. The authentication system of claim 5, wherein the integrated authentication center determines whether the respective pieces of user location information are identical to the pieces of user authentication information, received from the home gateway and the office gateway, and transmits the authentication success message to the specific system if it is determined that the respective pieces of user location information are identical to the pieces of user authentication information.

7. The authentication system of claim 1, wherein the home gateway and the office gateway include a camera for identifying an action or a face of the user and providing identified information.

8. The authentication system of claim 1, wherein the integrated authentication center transmits an authentication failure message to the specific system when the pieces of user authentication information are not identical to each other.

9. The authentication system of claim 1, wherein the information reader receives the device information of the user in a contact or non-contact manner.

10. The authentication system of claim 1, wherein the device is at least one of a RFID (Radio Frequency Identification) tag, a mobile terminal SIM (Subscriber Identity Module) card and a magnetic card.

11. An authentication method using device identification information in ubiquitous environment, comprising:
when a request for verification of authentication of a user is received from a specific system, individually requesting a home gateway and an office gateway to transmit authentication information of the user, registered in the home gateway and the office gateway;
determining whether pieces of user authentication information respectively received from the home gateway and the office gateway are identical to each other; and
transmitting an authentication success message to the specific system if it is determined that the pieces of user authentication information are identical to each other.

12. The authentication method of claim 11, wherein the home gateway performs a process including:
registering and managing the user authentication information received from an information reader;
collecting access information of the user in association with the registered user authentication information;
identifying the user based on the user authentication information and the user access information;
determining whether to provide a service to the user based on a result of the identification of the user; and
when a request for authentication information of a specific user is received from an integrated authentication center, transmitting authentication information of the specific user to the integrated authentication center, wherein the integrated authentication center integrates pieces of user authentication information and determines whether to authenticate the user.

13. The authentication method of claim 11, further comprising:
receiving information about an IP (Internet Protocol) address of a computer accessed by the user from the integrated authentication center and providing location information of the IP address.

14. The authentication method of claim 13, further comprising:
providing location information of a mobile terminal used by the user, based on signals transmitted or received by the mobile terminal.

15. The authentication method of claim 14, wherein said determining whether the pieces of user authentication information are identical to each other includes:
determining whether the location information of the IP address is identical to the location information of the mobile terminal, based on the respective pieces of location information; and
transmitting an authentication success message to the specific system if it is determined that the respective pieces of location information are identical to each other.

16. The authentication method of claim 11, wherein said determining whether the pieces of user authentication information are identical to each other further includes:
determining whether the respective pieces of location information are identical to the pieces of user authentication information received from the home gateway and the office gateway; and
transmitting the authentication success message to the specific system if it is determined that the respective pieces of location information are identical to the pieces of user authentication information.

17. The authentication method of claim 11, further comprising:
identifying an action and a face of the user through a camera provided in the home gateway and the office gateway, and providing identified information.

18. The authentication method of claim 11, further comprising:
transmitting an authentication failure message to the specific system if it is determined that the pieces of user authentication information are not identical to each other.

19. The authentication method of claim 11, wherein the information reader receives the device information of the user in a contact or non-contact manner.

20. The authentication method of claim 11, wherein the device is at least one of a RFID (Radio Frequency Identification) tag, a mobile terminal SIM (Subscriber Identity Module) card and a magnetic card.
